(19) United States
(12) Patent Application Publication
(10) Pub. No.: US 2012/0095793 A1
(43) Pub. Date: Apr. 19, 2012

(54) Business intelligence exception analysis by cause and effect

(75) Inventor: Jakob Averbuch, Netanya (IL)

(73) Assignee: Panorama Software Inc., New York, NY (US)

(21) Appl. No.: 12/923,961

(22) Filed: Oct. 18, 2010

(51) Int. Cl. G06F 17/30

(52) U.S. Cl. 705/7.11

(57) ABSTRACT

A computerized Cause and Effect exception analysis mechanism for multi-dimensional data, comprising: displaying a business report comprising data cells, each data cell pertaining to coordinates of one row and one column representing dimensions of the report, marking one or more of the displayed cells as exceptions according to an exception rule, receiving a selection of one or more of the marked cells, defining the coordinates of the selected cells as fixed coordinates, displaying a list of dimensions, receiving a selection of one or more dimensions from the displayed list, receiving a number N of reports to be displayed, compiling a list of combinations of the selected dimensions, slicing each combination in the list by the fixed coordinates, applying the exception rule to the sliced combinations, prioritizing the sliced combinations, selecting the N highest priority combinations, creating reports for the N selected combinations, and displaying the N created reports, each displayed report comprising at least one cell marked as exception.

### FIELD OF THE INVENTION

The present invention relates generally to electronic business technology and business processes, and more particularly, to an exception analysis method and system.

### BACKGROUND

Online Analytical Processing, or OLAP is an approach known in the art to quickly provide answers to analytical queries that are multidimensional in nature. The typical applications of OLAP are in business reporting for sales, marketing, management reporting, business process management (BPM), budgeting and forecasting, financial reporting and similar areas.

Databases configured for OLAP employ a multidimensional data model, allowing for complex analytical and ad-hoc queries with a rapid execution time. The output of an OLAP query is typically displayed in a matrix (or pivot) format. The dimensions form the is row and column of the matrix; the measures, the values.

In the core of any OLAP system is a concept of an OLAP cube (also called a multidimensional cube or a hypercube). It consists of numeric facts called measures which are categorized by dimensions. The cube metadata is typically created from a star schema or snowflake schema of tables in a relational database. Measures are derived from the records in the fact table and dimensions are derived from the dimension tables.

Using OLAP technologies is a complex task. Since the technology is based on multidimensional indexing of data, a major part of the analysis performed when using the BI system comprises of finding the correct “View” of the data. The user “slices” the information, using different dimensions, e.g. customer gender, various filtering rules, e.g. top ten selling products, etc, so as to define a view which will provide the relevant business insight, or a content to be used for creating an interesting report.

Business Intelligence systems involve exception reporting, which allows users to define threshold points and monitor Key Performance Indicators (KPIs)/Key Performance Metrics or get alerted only upon those exception conditions. Alerting enables management by notifying performance managers, executives and users when key exceptions occur.

Exception analysis helps users in determining the causes of exceptions. For example, the analysis may show that delays in a supply chain process occur whenever a specific supplier is involved. Understanding the causes of exceptions can help information technology and business manager to identify the changes required to avoid future occurrences of the exceptions. For example, the company may decide to remove a given supplier from its approved list.

When trying to analyze an exception in multidimensional data, e.g. a decline in sales in Europe over the last quarter, the user is faced with a difficult task of trying to understand what are the attributes of sales that have contributed mostly to the decline; is it because of an issue in Germany? Does it relate to a certain promotion? Is there a specific month that has mostly contributed to the decline? . . . In order to answer these questions, the user needs to ‘play’ with combinations of the sales attributes, which may easily end up with hundreds or thousands of combinations, which makes this process impossible to perform.

There is need for an automatic or semi-automatic process of exception analysis in multidimensional data.

### SUMMARY

According to a first aspect of the present invention there is provided a computerized Cause and Effect exception analysis mechanism for multi-dimensional data, comprising: displaying a business report comprising data cells, each data cell pertaining to coordinates of one row and one column representing dimensions of the report; marking one or more of the displayed cells as exceptions according to an exception rule; receiving a selection of one or more of the marked cells; defining the coordinates of the one or more selected cells as fixed coordinates; displaying a list of dimensions; receiving a selection of one or more dimensions from the displayed list; receiving a number N of reports to be displayed; compiling a list of combinations of the selected dimensions; slicing each combination in said list of combinations by said fixed coordinates; applying said exception rule to the sliced combinations; prioritizing the sliced combinations; selecting the N highest priority combinations; creating reports for the N selected combinations; and displaying the N created reports, each said displayed reports comprising at least one cell marked as exception.

The step of receiving a selection of one or more marked cells may comprise automatically selecting all marked cells.

The step of receiving a selection of one or more dimensions may comprise receiving a selection of a level within said dimension.

The step of compiling a list of combinations may comprise removing from said list of combinations, combinations which include at least one said fixed coordinates, wherein said fixed coordinate does not constitute a hierarchy.

The step of compiling a list of combinations may comprise drilling down to the descendents of combinations which include at least one said fixed coordinates, wherein said fixed coordinate constitutes a hierarchy.

The step of prioritizing the combinations may comprise calculating a weight for each said combinations.

The step of calculating a weight may comprise calculating for each combination a density factor and a quality factor.

The density factor may comprise the ratio between the number of exceptional cells in a combination and the total number of exceptional cells.

The quality factor may be defined by a quality formula on the exception rule.

The mechanism may additionally comprise displaying a history path of all previously displayed views.

The said displayed business report may be selected from said displayed history path.

According to a second aspect of the present invention there is provided a computer storage medium tangibly embodying a program of machine-readable instructions executable by a digital processing apparatus to perform the method of displaying a business report comprising data cells, each data cell pertaining to coordinates of one row and one column representing dimensions of the report; marking one or more of the displayed cells as exceptions according to an exception rule; receiving a selection of one or more of the marked cells; defining the coordinates of the one or more selected cells as fixed coordinates; displaying a list of dimensions; receiving a selection of one or more dimensions from the displayed list; receiving a number N of reports to be displayed; compiling a list of combinations of the selected dimensions; slicing each combination in said list of combinations by said fixed coordinates; applying said exception rule to the sliced combinations; prioritizing the sliced combinations; selecting the N highest priority combinations; creating reports for the N selected combinations; and displaying the N created reports, each said displayed reports comprising at least one cell marked as exception.

According to a third aspect of the present invention there is provided a computerized Cause and Effect exception analysis system for multi-dimensional data, comprising: a server storing a multi-dimensional database; a client computer storing a business intelligence application, said client computer communicating bi-directionally with said server; display means connected with said client computer, said display means adapted to display business reports comprising data cells, each said data cell pertaining to coordinates of one row and one column representing dimensions of the report, one or more of said displayed cells marked as exceptions according to an exception rule; GUI means stored on said client computer, said GUI means adapted to receive a selection of one or more of said marked cells, a selection of one or more dimensions pertaining to said selected cells and a number N of reports to be displayed; and a software module stored on the server, adapted to define the coordinates of said selected cell as fixed coordinates, compile a list of combinations of the selected dimensions, slice each combination in said list of combinations by said fixed coordinates, apply said exception rule to the sliced combinations, prioritize the sliced combinations, select the N highest priority combinations and create reports for the N selected combinations.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a flowchart showing the various steps taken by the user in implementing the Cause and Effect process according to the present invention;

FIG. 2 is a flowchart showing the various steps taken by the server in implementing the Cause and Effect process according to the present invention;

FIG. 3 is a flowchart showing in detail the prioritization and weight calculation of combinations of attributes;

FIG. 4 is a schematic drawing of an exemplary Graphical User Interface (GUI) for implementing the Cause and Effect process according to the present invention;

FIG. 5 shows an exemplary view currently viewed by the user;

FIG. 6 is an exemplary report resulting from the implementation of the Cause and effect process according to the present invention; and

FIG. 7 is a schematic representation of a system for carrying out the Cause and Effect process according to the present invention.

### DETAILED DESCRIPTION OF PREFERRED EMBODIMENTS

In the following detailed description, numerous specific details are set forth regarding the system and method and the environment in which the system and method may operate, etc., in order to provide a thorough understanding of the present invention. It will be apparent, however, to one skilled in the art that the present invention may be practiced without such specific details. In other instances, well-known components, structures and techniques have not been shown in detail to avoid unnecessarily obscuring the subject matter of the present invention. Moreover, various examples are provided to explain the operation of the present invention. It should be understood that these examples are exemplary. It is contemplated that there are other methods and systems that are within the scope of the present invention.

The method of the present invention, as incorporated in a computer program, may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus. In addition, embodiments of the present invention are not described with reference to any particular programming language. It will be appreciated that a variety of programming languages may be used to implement the teachings of the inventions as described herein.

The system and method of the present invention provide a novel semi-automatic ‘Cause and effect’ exception analysis mechanism for users of business intelligence applications running over multi-dimensional databases.

The mechanism uses the Rule that created the exception as a drive for searching the cause.

The mechanism will go through various combinations of the attributes and will suggest to the user the most likely combinations, as additional reports. The user can continue his ‘cause and effect’ search from one of these reports to dig deeper into other possible causes of the exception. As the user builds a ‘path’ of ‘cause and effect’ reports, his ‘trail’ (history path) is kept to fine-tune the deeper search.

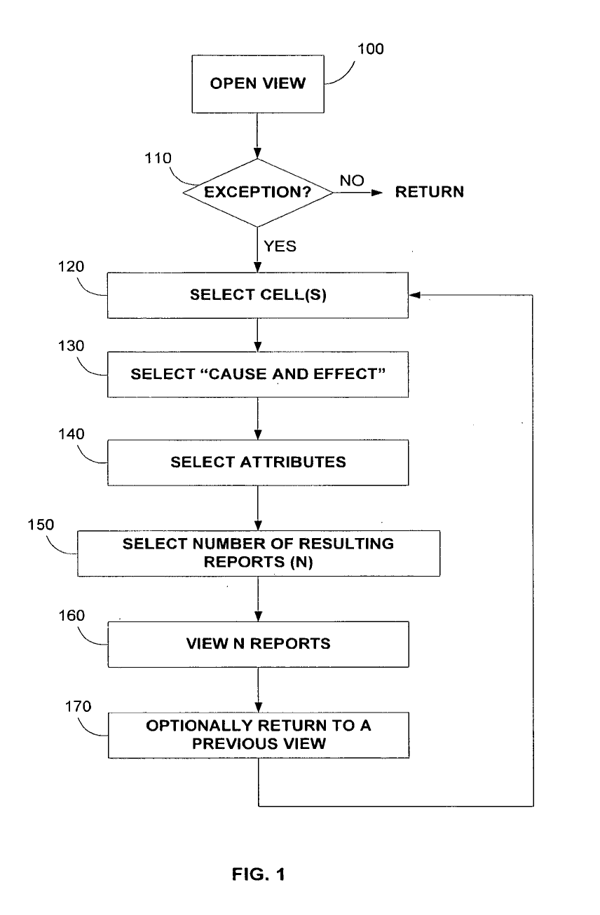

FIG. 1 is a flowchart showing the various steps taken by the user in implementing the Cause and Effect process according to the present invention.

In step 100 the user opens a view of interest and checks for exceptions (step 110). Exceptions will usually be visually highlighted on the displayed view. In order to analyze the possible causes for an exception, the user selects one or more highlighted cells (step 120) and uses a context menu to perform Cause and Effect analysis for the selected cell(s) (step 130). A user may select more than one highlighted cell if, for example, he wishes to analyze an exception (e.g. sales drop beneath a predefine percentage) in several cities. Another option is that the system will automatically select ALL highlighted cells and “drill” into all of them. The user is now presented with a dialogue box, allowing him to select:
a. Step 140—What attributes\dimensions should the system dig deeper into. A list of attributes is displayed, which may include dimensions already existing in the crosstab. In a dimension, the user may select levels, for example, he may select the city level in a geography dimension. If the user does no selection, all dimension and attributes in the crosstab and slicers will participate in the Cause and Effect search.
b. Step 150—How many reports (N) to return simultaneously in each step of the analysis.

In step 160 the user views the N reports compiled by the Cause and Effect mechanism in response to his request and the history of his previous selections. Each new report will have cells highlighted by the same exception rule. These reports will show how other attributes have contributed to the problem.

In step 170 the user may go back one or more steps by selecting any view in the history path. This will return the displayed views to show those N view that relate to the currently selected view.

At any given moment in the course of the Cause and Effect analysis the user may drag a displayed view into the history path, to be accessible for further analysis.

Alternatively, the user may proceed to select another problematic cell in one of the N new reports for continuing the Cause and Effect analysis.

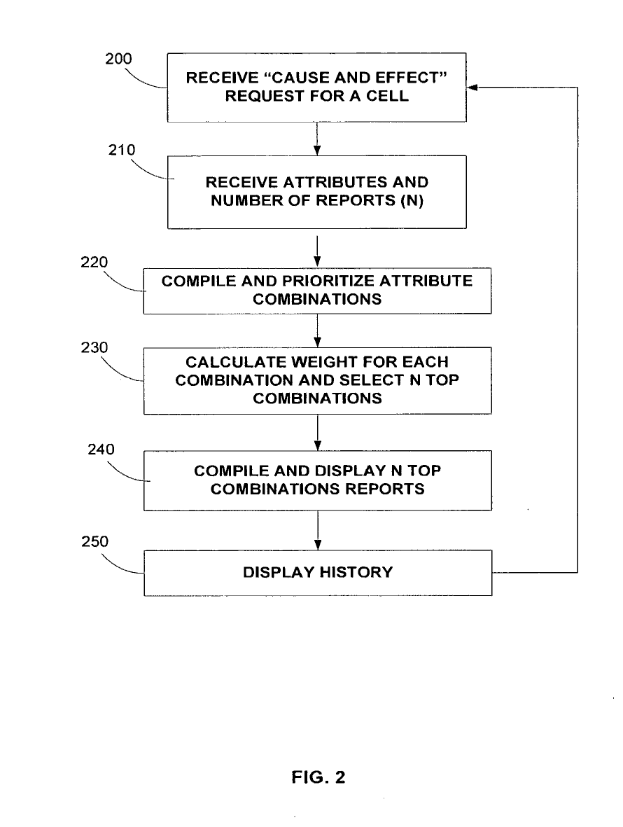

FIG. 2 is a flowchart showing the various steps taken by the server in implementing the Cause and Effect process according to the present invention.

In step 200 the server receives a Cause and Effect analysis request for one or more cells in the view currently displayed to the user.

In step 210 the server receives the attributes (dimension) selected by the user from a displayed context menu and the number of reports (N) the user wishes to be displayed simultaneously in each step of the analysis. If no attributes are selected, all the attributes will be taken into consideration.

In step 220 the server proceeds to compile and prioritize the various combinations of the selected attributes, where the originally selected cell is ‘hard coded’ ('fixed coordinate') and in step 230 a weight is calculated for each combination and the N highest weight combinations are selected for reporting.

In step 240 reports (views) are compiled and displayed for the selected N combinations and in step 250 the history (path) of displayed reports is displayed, enabling the user to go back to a previously displayed report and continue his analysis from there.

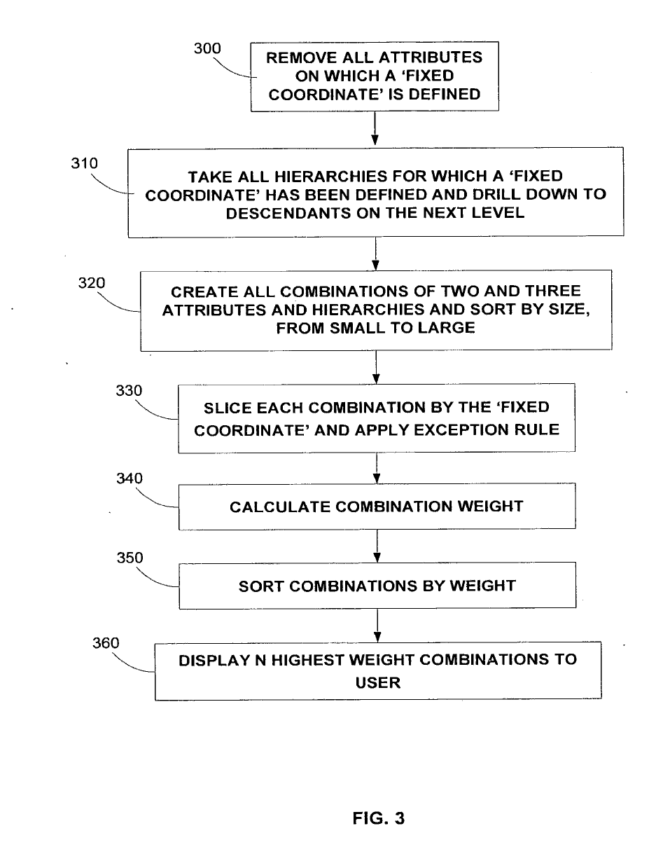

FIG. 3 is a flowchart showing in detail the prioritization and weight calculation of combinations of attributes (steps 220, 230 of FIG. 2).

In step 300 all attributes on which at least one ‘fixed coordinate’ is defined are removed from consideration, since these attributes are already considered.

In step 310 all hierarchies (i.e. attributes with more than one level) for which at least one ‘fixed coordinate’ is defined are drilled down to their descendents of the ‘fixed coordinate’ in the next level (e.g. months or cities).

In step 320 the server creates all the combinations of two and three attributes and hierarchies of step 310 and sorts the combinations by size, preferably from small to large. Sorting the combinations from small to large will enable the user to start his Cause and Effect analysis using higher level information, which may require one or more analysis steps but will prevent loss of information.

In step 330 each combination is sliced by the ‘fixed coordinate’ and the exception rule is applied to the slicing result.

In step 340 the server now proceeds to calculating weights for each one of the sliced combinations.

The combination weight is defined by two factors:
1. Combination density—the ratio between number of exceptional cells in a combination and the total number of cells.
2. Combination quality—the combination quality of each exceptional cell. Combination quality is defined by a quality formula on the exception rule. For example, the exception rule may define ‘highlight all cells where growth percent <0%’, while combination quality is defined by ‘growth quality’, a value between 1-10 defining the exception quality, the higher, the better quality. For example, growth<−90% may result in ‘10’ while −10%<growth<0% may result in the value of ‘1’.

The calculated combination density and quality are used to calculate the combination weight, e.g. as a sum of the exceptional cells quality multiplied by the combination density.

It will be understood that other formulas may be used for determining a combination quality and weight, and that the above formulas are given as examples.

In step 350 the combinations are sorted by their calculated weight and in step 360 the top N combinations, having the highest weight, are displayed to the user for further investigation.

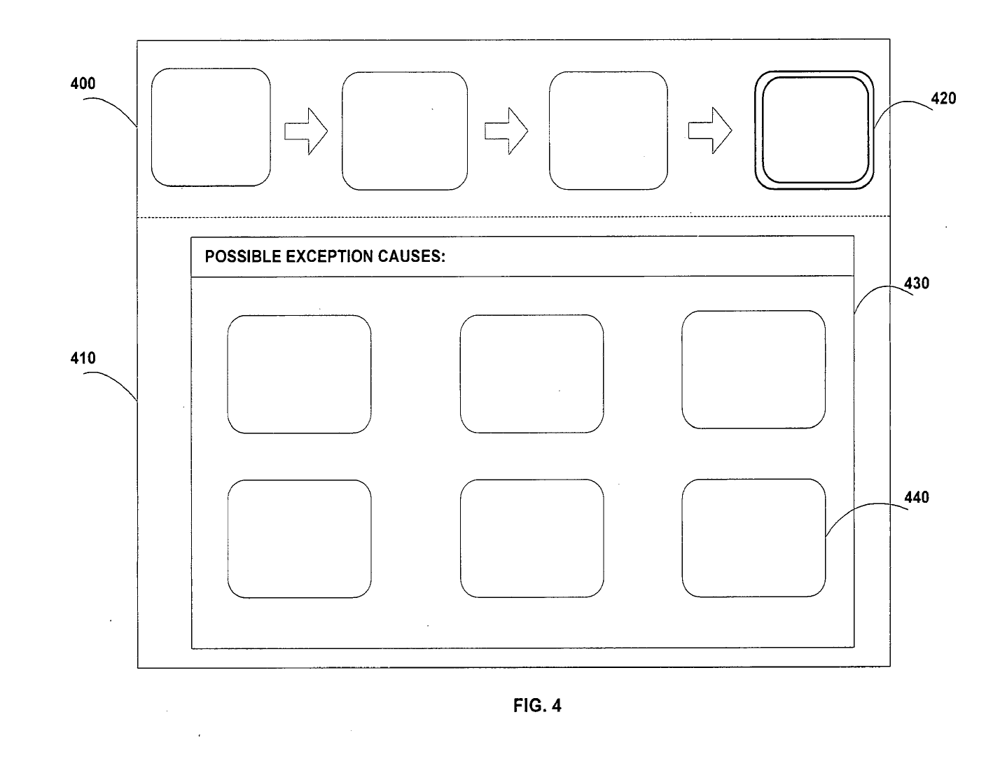

FIG. 4 is a schematic drawing of an exemplary Graphical User Interface (GUI) for implementing the Cause and Effect process according to the present invention, comprising an upper display portion 400 and a lower display portion 410.

The upper display portion 400 displays the history (path) of the Cause and Effect analysis performed so far, with the last view selected for analysis (420) highlighted.

The lower display portion 410 displays the possible problem causes 430 in N=6 reports (views) 440 compiled by the server from view 420 and the attributes selected for its analysis.

### EXAMPLE

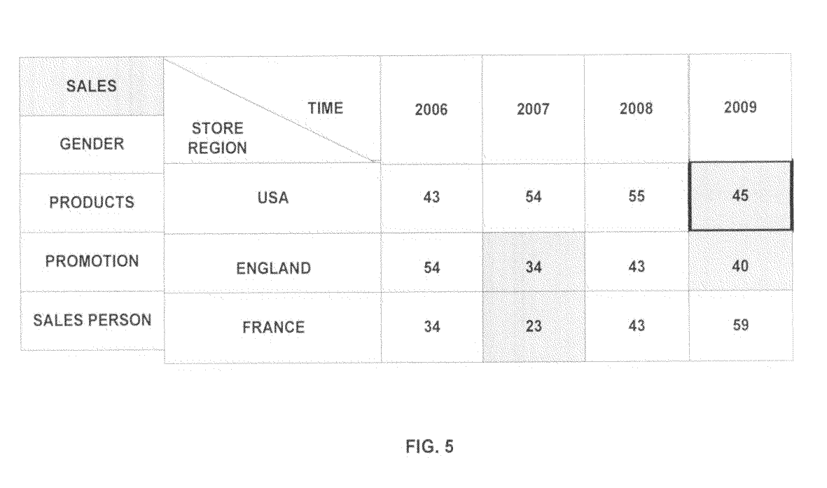

FIG. 5 shows an exemplary view currently viewed by the user. The view shows sales in store regions across time and the exception rule applied is “Sales growth from last period <0”. The measure currently viewed is “Sales”. Several cells which comply with the rule are highlighted, namely cells Sales-England-2007, Sales-France-2007, Sales-USA-2009 and Sales-England-2009. Other dimensions not currently viewed are: “Gender”, “Products”, “Promotion” and “Sales Person”.

The user now indicates his wish to perform a Cause and Effect analysis on the cell Sales-USA-2009, e.g. by selecting the cell and choosing the required operation from a pull-down menu (not-shown), or by any other GUI means known in the art.

The user is then presented with the option to select other dimensions/attributes by which the server should analyze the exception and to select the number of reports he would like to be shown after each analysis stage.

In our example, the user makes no selection of attributes, which results in all the attributes being selected, namely:

Gender—having 2 levels of hierarchy: All genders/male-female

Products—Having 4 levels of hierarchy: All products/Product category/Product sub-category/Product

Promotions—Having 2 levels of hierarchy: All promotions/Promotion

Sales person—Having 3 levels of hierarchy: All sales persons/Sales person area/Sales person

The attribute “Sales” is removed, since it has a fixed coordinate defined (step 300, FIG. 3).

The attributes “Time”, “Store region”, “Gender”, “Products”, “Promotions” and “Sales person” are drilled down one level (Step 310, FIG. 3), whereby the attribute list now comprises:

2009 Quarters, USA States, Male-female, Product categories, promotion list and Sales person areas.

Next the server creates all the combinations of 2 or 3 attributes and hierarchies and sorts them by size, from small to large (Step 320, FIG. 3). In our example, some exemplary combinations will be:

Store (State)*Gender (Size=50*2=100)

Store (State)*Promotion (Size=50*4=200 assuming 4 promotion schedules)

Store (State)*Product category (Size=50*3=150 assuming 3 product categories)

Gender*Promotion (Size=2*4=8)

Gender*Product category (Size=2*3=6)

Promotion*Product category (Size=4*3=12)

Gender*Promotion*Product category (Size=2*4*3=24)

Gender*Time (Quarters) (Size=2*4=8)

Store (State)*Time (Quarters) (Size=50*4=200)

Promotion*Time (Quarters) (Size=4*4=16)

Etc.

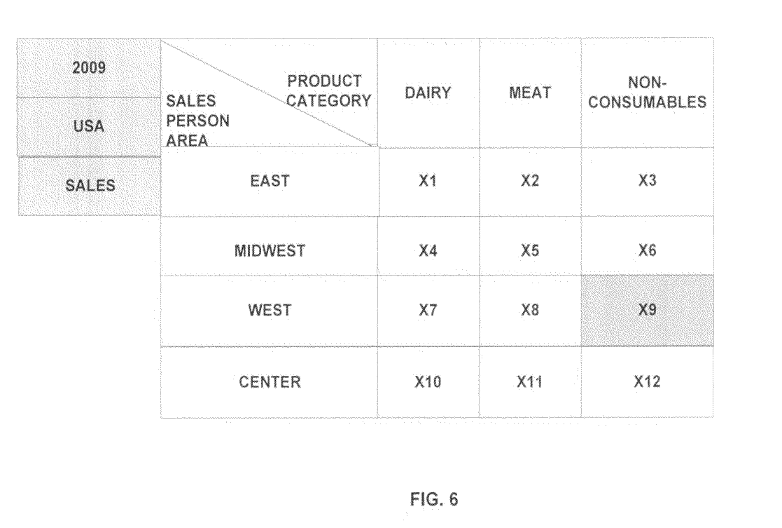

Each combination is now sliced by the fixed coordinate “Sales” and the exception rule “Sales growth from last period <0” applied, resulting in multiple tables, as exemplified by the table of FIG. 6.

We assume the table of FIG. 6 has been ranked high enough to be selected for viewing by the user as one of the N displayed tables.

The table of FIG. 6 has as fixed coordinates: 2009, USA, Sales, Sales person area and product category.

One cell (X9) is highlighted to denote that the 2009 sales figure in the west area of non-consumable products has growth <0 as compared to 2008 sales in the west area of non-consumable products.

If the user now chooses to continue the analysis for cell X9, “Non-consumables” and “West” will be added to the fixed coordinates. The analysis will proceed by drilling down one level:
In the non-consumables, to the non-consumable products level
In the west area to the level of sales persons in the west area
In 2009 to the level of Quarters
In USA to the level of states

The analysis proceed in the same manner till the user is satisfied that he has enough information to determine the causes of the original exception.

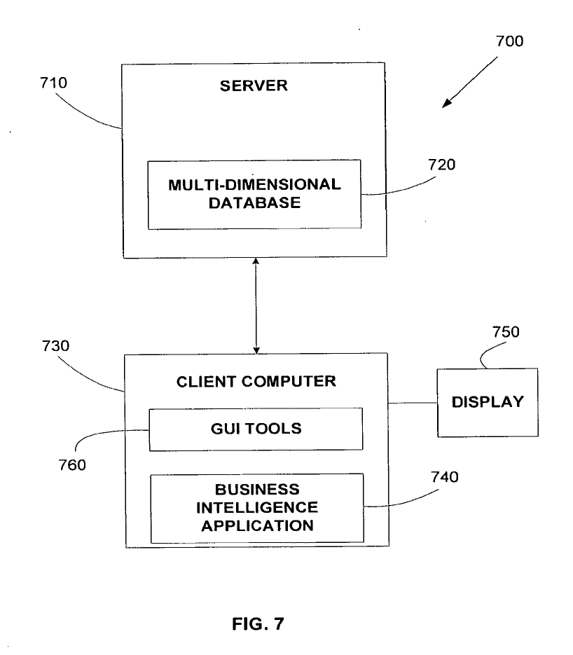

FIG. 7 is a schematic representation of a system for carrying out the Cause and Effect mechanism according to the present invention.

The system 700 comprises a server 710, such as Windows 2008 server, storing a multi-dimensional database 720.

A client computer 730, IBM PC storing a business intelligence application 740, such as NovaView web client, communicates bi-directionally with the server 710 located either in the Intranet or on the Internet. The client computer 730 comprises a display 750 and GUI (Graphical user Interface) tools 760.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof which would occur to persons skilled in the art upon reading the foregoing description.

1. A computerized Cause and Effect exception analysis mechanism for multi-dimensional data, comprising:
a. displaying a business report comprising data cells, each said data cell pertaining to coordinates of one row and one column representing dimensions of the report;
b. marking one or more of said displayed cells as exceptions according to an exception rule;
c. receiving a selection of one or more of said marked cells;
d. defining the coordinates of said one or more selected cells as fixed coordinates;
e. displaying a list of dimensions;
f. receiving a selection of one or more dimensions from the displayed list;
g. receiving a number N of reports to be displayed;
h. compiling a list of combinations of the selected dimensions;
i. slicing each combination in said list of combinations by said fixed coordinates;
j. applying said exception rule to the sliced combinations;
k. prioritizing the sliced combinations;
l. selecting the N highest priority combinations;
m. creating reports for the N selected combinations;
n. displaying the N created reports, each said displayed reports comprising at least one cell marked as exception; and
o. repeating steps (c) through (n).

2. The mechanism of claim 1, wherein said receiving a selection of one or more marked cells comprises automatically selecting all marked cells.

3. The mechanism of claim 1, wherein said receiving a selection of one or more dimensions comprises receiving a selection of a level within said dimension.

4. The mechanism of claim 1, wherein said compiling a list of combinations comprises removing from said list of combinations, combinations which include at least one said fixed coordinates, wherein said fixed coordinate does not constitute a hierarchy.

5. The mechanism of claim 1, wherein said compiling a list of combinations comprises drilling down to the descendents of combinations which include at least one said fixed coordinates, wherein said fixed coordinate constitutes a hierarchy.

6. The mechanism of claim 1, wherein said prioritizing the combinations comprises calculating a weight for each said combinations.

7. The mechanism of claim 6, wherein said calculating a weight comprises calculating for each combination a density factor and a quality factor.

8. The mechanism of claim 7, wherein said density factor comprises the ratio between the number of exceptional cells in a combination and the total number of exceptional cells.

9. The mechanism of claim 7, wherein said quality factor is defined by a quality formula on the exception rule.

10. The mechanism of claim 1, additionally comprising displaying a history path of all previously displayed views.

11. The mechanism of claim 10, wherein said displayed business report is selected from said displayed history path.

12. A computer storage medium tangibly embodying a program of machine-readable instructions executable by a digital processing apparatus to perform the method of claim 1.

13. A computerized Cause and Effect exception analysis system for multi-dimensional data, comprising:
a server storing a multi-dimensional database;
a client computer storing a business intelligence application, said client computer communicating bi-directionally with said server;
display means connected with said client computer, said display means adapted to display business reports comprising data cells, each said data cell pertaining to coordinates of one row and one column representing dimensions of the report, one or more of said displayed cells marked as exceptions according to an exception rule;
GUI means stored on said client computer, said GUI means adapted to receive a selection of one or more of said marked cells, a selection of one or more dimensions pertaining to said selected cells and a number N of reports to be displayed; and
a software module stored on the server, adapted to define the coordinates of said selected cell as fixed coordinates, compile a list of combinations of the selected dimensions, slice each combination in said list of combinations by said fixed coordinates, apply said exception rule to the sliced combinations, to prioritize the sliced combinations, select the N highest priority combinations and create reports for the N selected combinations.
